(19) United States
(12) Patent Application Publication
(10) Pub. No.: US 2005/0157903 A1
(43) Pub. Date: Jul. 21, 2005

(54) Headset

(75) Inventor: Martin Bech, Frederikssund (DK)

Correspondence Address: Altera Law Group, LLC, Suite 100, 6500 City West Parkway, Minneapolis, MN, 55344-7701, US

(73) Assignee: GN Netcom, A/S, Ballerup (DK)

(21) Appl. No.: 11/036,510

(22) Filed: Dec. 20, 2004

(30) Foreign Application Priority Data
Jun. 20, 2002 (DK) PA 2002 00941
Jun. 18, 2003 (WO) PCT/DK03/00403

(51) Int. Cl. H04R 25/00

(52) U.S. Cl. 381/370; 381/381; 381/375

(57) ABSTRACT

A headset with a headband is equipped with at least one cup in which a male or female plug is arranged. The cup is intended for the mounting of a speaker or a speaker with microphone arm, said speaker or speaker with microphone arm being also provided with a male or female plug adapted to be connected to the male or female plug in the cup. The headband of the headset is hollow so that the wire may be run from one side of the headset to the other side. Hereby, the speaker and/or speaker with microphone arm of the headset may easily be replaced, without having to scrap the entire headset. Thus, it is possible to upgrade the headset currently for technical as well as aesthetic reasons. In an embodiment, the headset is provided with a cup at one side and at the other side with a T-member which constitutes a support part against a user's head.

The invention relates to a headset comprising a headband, where at least one of the ends of the headband is provided with an electrical male or female plug for the connection of a speaker.

Headsets of this type are known in numerous structures, cf. e.g. the headset described in WO 00/39983.

Such headsets are frequently connected to a stationary telephone apparatus, thereby making it possible to conduct conversations without a user having to operate the telephone apparatus by hand. The headset may be connected to the telephone apparatus via a wire or via a wireless connection of the Bluetooth type.

In step with the every increasing use of headsets, not only in connection with classic telephone apparatuses, exchanges, etc., but also in connection with mobile telephony, the technology is improved so that the headsets obtain a better sound quality. Further, the mechanical structure of the headsets is improved, e.g. in connection with coupling mechanisms between microphone arm and speaker part. Finally, the design plays an important role for the selection of headsets, especially as regards the design of the microphone arm itself.

With the development of new technology and/or design, it is normally so that the entire headset is replaced. This demands considerable resources and is not very environmentally friendly in view of the fact that an exchanged headset, which is replaced by a new one, frequently has the same headband and electrical connections between the two sides of the headset.

Finally, GB 2 309 351 A1 discloses a headset where there is contact connection in the headband and the speaker via a male and a female plug.

Accordingly, an object of the invention is to provide a headset which may be upgraded currently, both as regards technology and as regards design, but such that only the most necessary parts are to be replaced.

The object of the invention is achieved by a headset of the type defined in the introductory portion of claim 1, which is characterized in that the male or the female plug is disposed in a cup provided in the headset for receiving the speaker of the headset.

It is hereby possible to re-use the headband of the headset with wires and cup when its speaker or speaker with microphone arm, its mechanical parts and/or design are to be upgraded. It is moreover possible to adapt the same headset to various needs, quite simply by replacing the speaker or the speaker with microphone arm, which is useful if the headset is sometimes used for conversational purposes and in other cases for listening to music.

Expediently, the invention also finds useful application in upgrading, if, as stated in claim 2, a microphone arm is mounted on the speaker.

When, as stated in claim 3, an electrical male or female plug is provided in the speaker or the speaker with microphone arm, rapid replacement of a speaker and/or a speaker with microphone arm is achieved, since the parts are merely assembled and disassembled like an ordinary male or female plug.

To improve the flexibility additionally, it is an advantage if, as stated in claim 4, the headband is hollow, and electrical wires are run in it which connect one end of the male or female plug of the headband with a male or female plug at the opposite end of the headband, since the headset may then always be adapted to have a speaker at both sides.

Further expedient embodiments of the invention are defined in claims 5 and 6.

The invention will now be explained more fully with reference to the drawing, in which

FIG. 1 shows a headset according to the invention with a speaker and a cup,

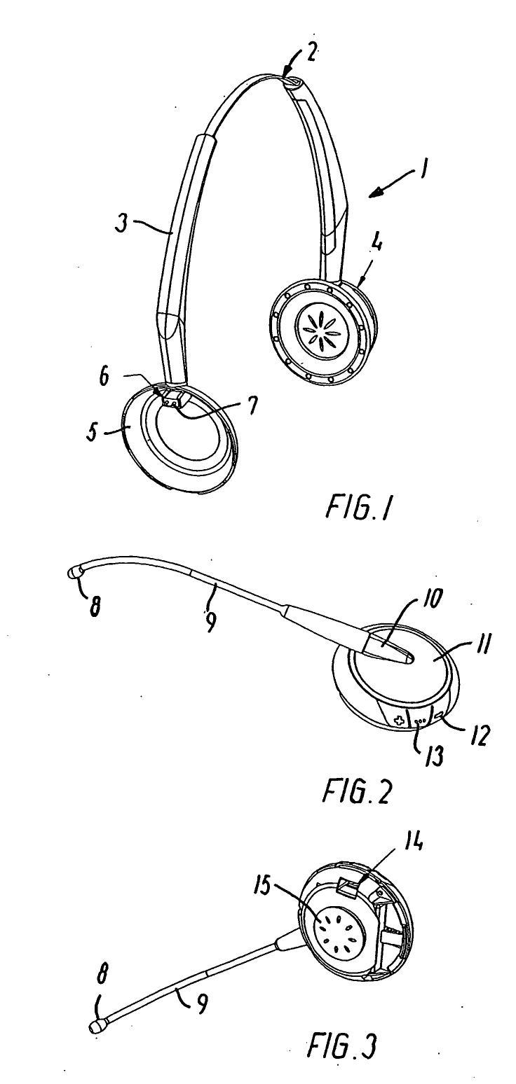

FIG. 2 shows a speaker with microphone arm to be mounted in the headset of FIG. 1,

FIG. 3 shows the speaker with microphone arm of FIG. 2 seen from another side,

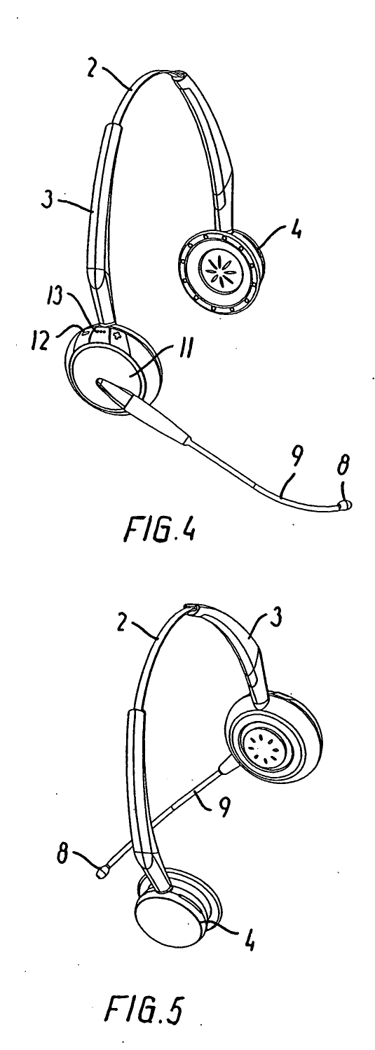

FIG. 4 shows the headset of FIG. 1 with mounted speaker and microphone arm, cf. FIGS. 1 and 2,

FIG. 5 shows the headset of FIG. 4 seen from another side,

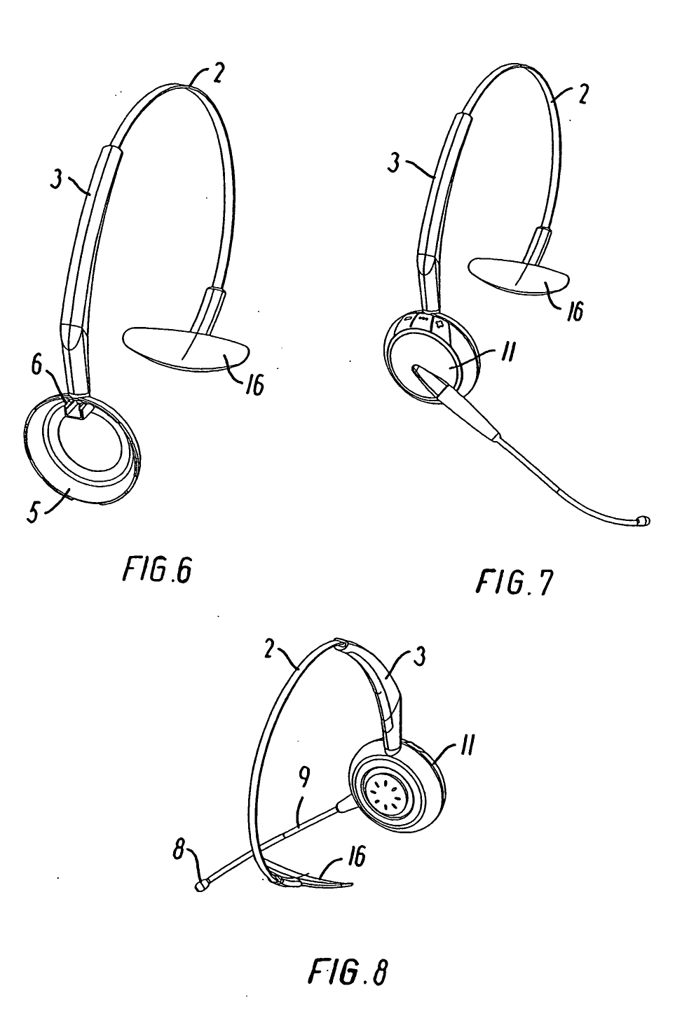

FIG. 6 shows another embodiment of the headset shown in FIG. 1,

FIG. 7 shows the headset of FIG. 6 with mounted speaker with microphone arm, while

FIG. 8 shows the headset of FIG. 7 seen from another side.

In FIG. 1, a headset according to the invention is generally designated 1. As will be seen, it consists of a headband 2 which may be adjusted by means of an adjustment mechanism 3 for adapting the headset to a user's head. A speaker 4 is mounted at one end of the headband, while at the other end of the headband there is mounted a cup 5 with a male plug 6 which has plug connections 7. It should be noted, however, that a female plug might be provided instead of the male plug.

The cup 5 is intended to receive the speaker 15 with microphone arm 9 and microphone 8 shown in FIG. 2 and FIG. 3.

As will be seen in FIG. 2, the microphone is connected to the speaker by means of a coupling mechanism 10 which makes it possible to manipulate the microphone arm 10 in various directions.

The speaker is disposed in a casing 11 which has an outer configuration that geometrically fits the cup 5 in FIG. 1.

FIG. 2 moreover shows that the buttons 12 are provided on the casing 11 for adjusting the sound of the headset as well as signal diodes 13.

As will be seen in FIG. 3, the casing has a female plug 14 which fits the male plug 6, which is shown in FIG. 1.

FIGS. 4 and 5 also show the headset of FIG. 1, but now with mounted microphone with the speaker of FIGS. 2 and 3. This mounting is performed in a simple manner by moving the casing with the female plug into the cup 5, whereby the male plug and the female plug are connected to each other.

The headband 2 is hollow so that wires (not shown) may be run in this to the speaker 4.

FIG. 6 shows another embodiment of the invention corresponding to that of FIG. 1, but, instead of the speaker 4, a T-member 16 is mounted at one side of the headset, said T-member serving as a support against a user's head.

FIG. 7 and FIG. 8 show the headset of FIG. 6, but now with mounted speaker and microphone 8 with microphone arm 9 in the same manner as the embodiments in FIG. 4 and FIG. 5.

1. A headset comprising a headband, where at least one of the ends of the headband is provided with an electrical male or female plug for the connection of a speaker wherein the male or female plug is disposed in a cup provided in the headset for receiving the speaker of the headset.

2. A headset according to claim 1, wherein a microphone arm is mounted on the speaker.

3. A headset according to claim 2, wherein an electrical male or female plug is provided in the speaker or in the speaker with microphone arm.

4. A headset according to claim 3, wherein the headband is hollow, and that electrical wires are run in it which connect one end of the male or female plug of the headband with a male or female plug at the opposite end of the headband.

5. A headset according to claim 3, wherein one end of the headband is terminated by a support member.

6. A headset according to claim 5, wherein the speaker or the speaker the microphone arm is incorporated in a casing having dimensions which correspond to the dimensions of the cup.
